(19) United States
(12) Patent Application Publication
(10) Pub. No.: US 2002/0078001 A1
(43) Pub. Date: Jun. 20, 2002

(54) Use of schema in a hierarchy to represent associations of hierarchy nodes

(76) Inventor: Joseph Herbert McIntyre, Austin, TX (US)

Correspondence Address: Duke W. Yee, Carstens, Yee & Cahoon, LLP, P.O. Box 802334, Dallas, TX, 75380, US

(21) Appl. No.: 09/737,345

(22) Filed: Dec. 15, 2000

(51) Int. Cl. G06F 7/00

(52) U.S. Cl. 707/1

(57) ABSTRACT

A method, system, program product, and data structure for utilizing the schema of a hierarchy to represent a reference association between nodes, to allow a reference association to hold properties, and for reference associations to be used in the coalescing of properties. In one embodiment, a first child node is added to the hierarchy node that holds the reference association. From a second child node, the location of the reference association is determined whose presence is indicated by a delimiter. The reference association node contains properties to be associated with the second child node. The reference association node is located to obtain properties to be coalesced with the properties of the second child node.

### BACKGROUND OF THE INVENTION

1. Technical Field:

The present invention relates generally to computer software and, more particularly to management of data.

2. Description of Related Art:

Hierarchical data structures are used in a variety of applications. Each node within the hierarchy may contain a set of properties. The primary function of a hierarchical data structure is to provide a structure in which the location of a node is relative to a parent node to which it is associated. This parent/child association is represented in a schema through the use of a delimiter, where a succession of layers can be represented. For instance, a schema entry for a user ‘John’ within the set of child nodes under the parent node ‘user’, may be represented as ‘/user/John’ where the ‘/’ character is used as the delimiter.

In addition to the association of a child node to a parent node, nodes may be associated to each other. A common prior art method for storing this type of association utilizes a property within a node to hold a reference to its associated node. For instance, a user may have a desktop associated with his or her logon to a networked computer. The user node may have a property, ‘desktop’ that contains the value ‘/desktop/finance’ that is a reference to that particular desktop node. This mechanism requires that the properties of a node be inspected in order to traverse this type of association. It would be desirable, therefore, to have a method of relating associations to each node in a more efficient manner.

When properties are coalesced, that is when a number of nodes are traversed to determine an aggregate set of properties, a common prior art approach requires that nodes exist under associated hierarchies to hold the properties of an association. For instance, in the desktop example, if /user/john had a different desktop background color than that specified in /desktop/finance, then an additional node would have to be created under /desktop/finance (i.e. /desktop/finance/john) to hold this additional property. If the /user/john node was removed, then /desktop/finance/john would be orphaned unless program logic existed to handle this case. It is therefore desirable to have a mechanism in which this type of association can have properties of its own, and for this type of association to be utilized in coalescing to improve efficiency and prevent orphan nodes being left in the hierarchy.

### SUMMARY OF THE INVENTION

The present invention provides a method, system, program product, and data structure for utilizing the schema of a hierarchy to represent a reference association between nodes, to allow a reference association to hold properties, and for reference associations to be used in the coalescing of properties. In one embodiment, a first child node is added to the hierarchy node that holds the reference association. From a second child node, the location of the reference association is determined whose presence is indicated by a delimiter. The reference association node contains properties to be associated with the second child node. The reference association node is located to obtain properties to be coalesced with the properties of the second child node.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIGS. 4-6 depict diagrams illustrating exemplary hierarchical structure of nodes in accordance with the present invention; and

FIG. 7 depicts a diagram illustrating a program flow for determining the properties of a node within a hierarchical schema in accordance with the present invention.

### DETAILED DESCRIPTION OF THE PREFERRED EMBODIMENT

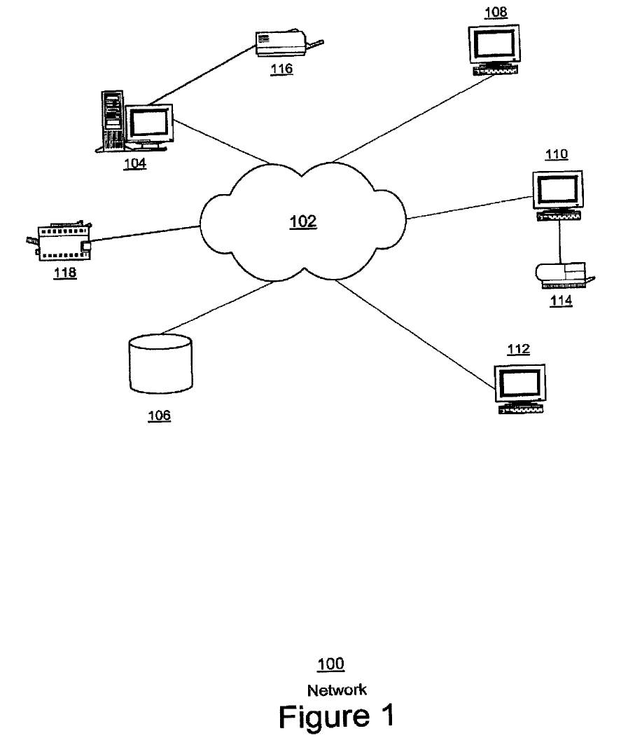

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

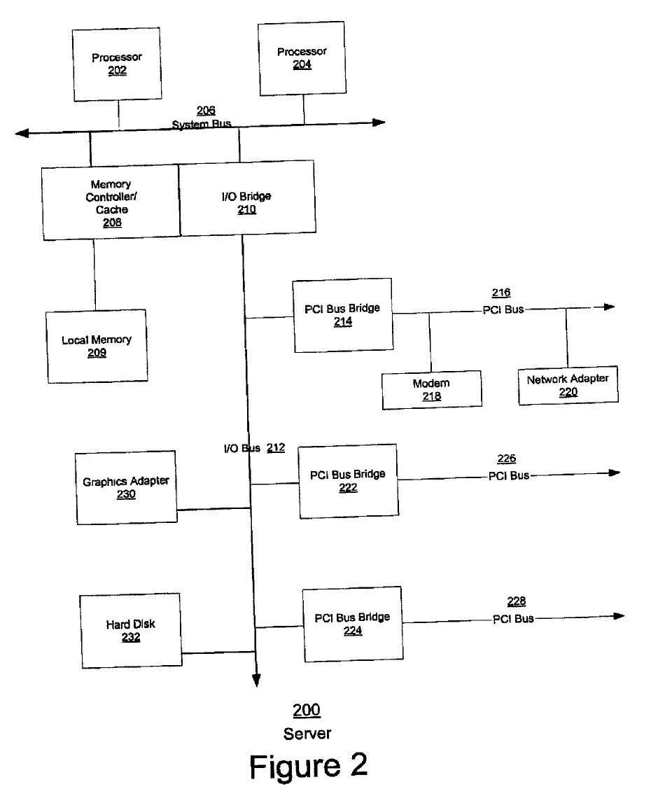

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

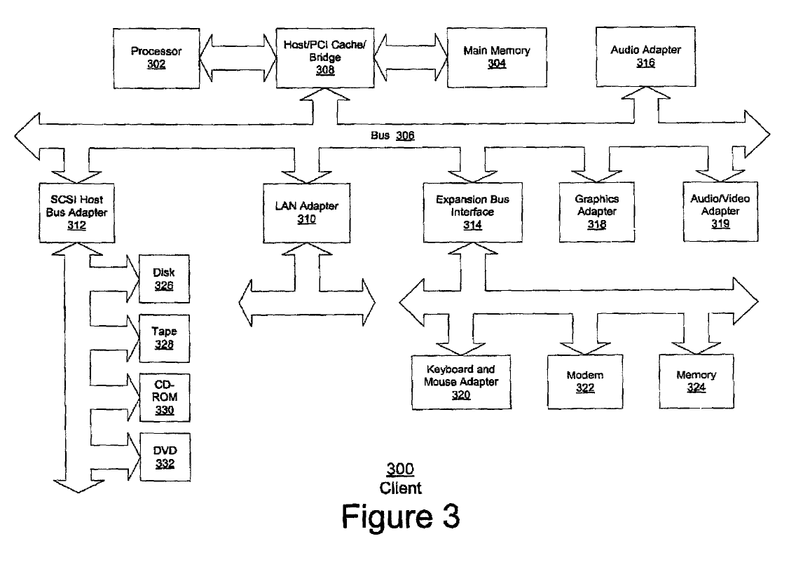

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

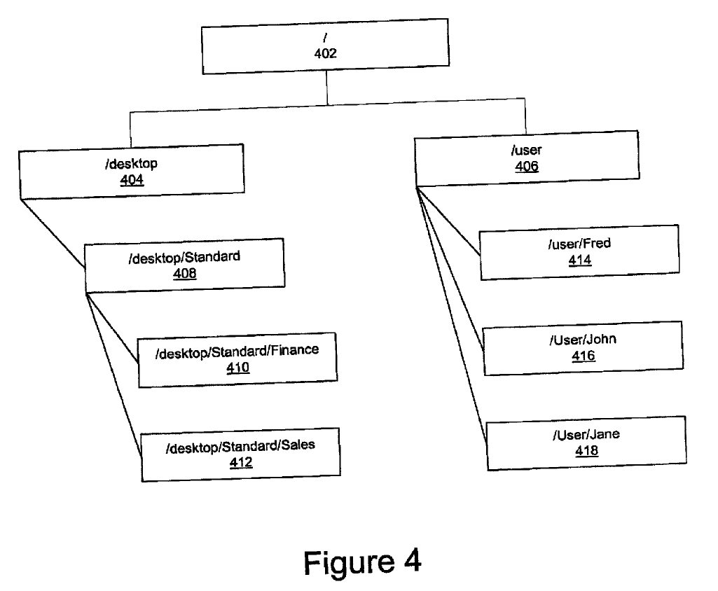

With reference now to FIGS. 4-6, diagrams illustrating exemplary hierarchical structure of nodes are depicted in accordance with the present invention. These diagrams use the example of users and desktops to illustrate a reasonable application, however, in other embodiments, other types of nodes could be used.

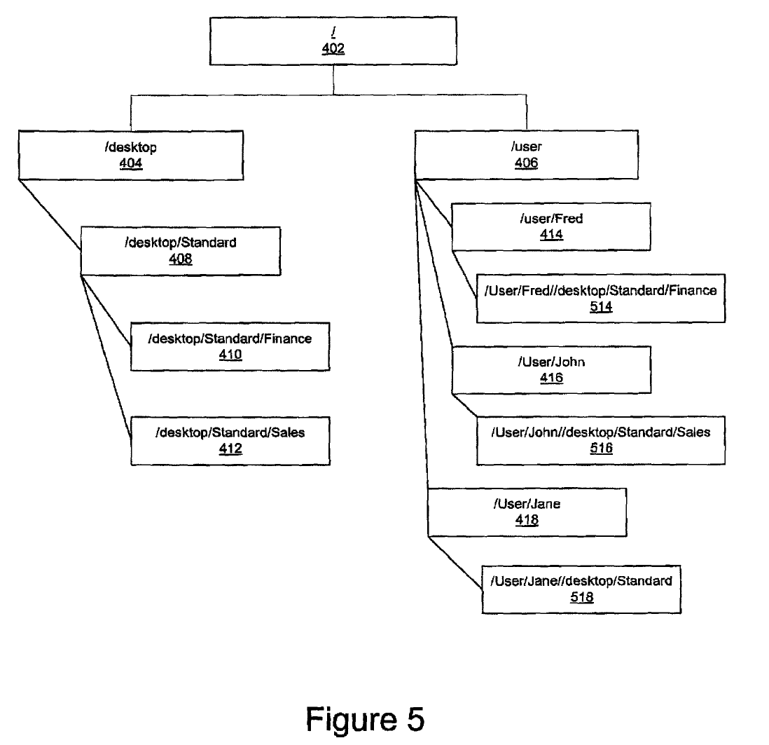

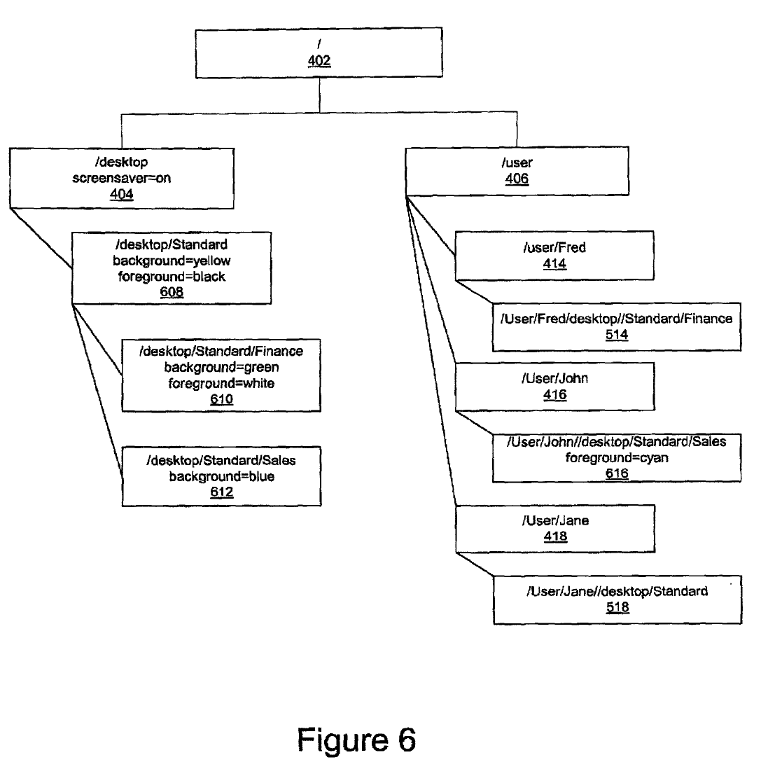

FIG. 4 shows a simple hierarchy of nodes. There are no reference associations nor properties shown. FIG. 5 extends FIG. 4 by adding reference associations between the /user branch and /desktop branch of the hierarchy. FIG. 6 extends FIG. 5 by adding properties to some of the nodes.

Referring first to FIG. 4, in this example, the system has a top node 402 that is divided into two first level child nodes, node /desktop 404 and node /user 406. However, in other embodiments, the top node 402 could be split into many more sub-nodes than the two depicted here.

Each of the first level child nodes 404-406 is further split into a second level of child nodes. Node /desktop 404 has a child node /desktop/Standard 408 which in turn is split into two more child nodes, /desktop/Standard/Finance 410 and /desktop/Standard/Sales 412. Node /user 406 is split into three child node, /user/Fred 414, /user/John 416, and /user/Jane 418. These user nodes 414-418 correspond to each user on the network.

Referring next to FIG. 5, each user node 414-418 may comprise the hierarchical name of the node as well as a node associated by reference, separated by a special delimiter. For example, node 414 contains node 514 which is a reference association from node “/user/Fred” to the node “/desktop/Standard/Finance”. In the schema for the hierarchy, the associated node /desktop/Standard/Finance is separated from the name of the node (i.e. /user/Fred) by a special delimiter, “//” thus indicating that “desktop/Standard/Finance” is a reference association from the node “/user/Fred”. This reference association node may contain properties that Fred desires for his desktop. Thus, the reference association node may participate in coalescing of properties.

Thus, FIG. 5 demonstrates utilizing the schema of the hierarchy, instead of properties within hierarchy nodes, to create reference associations between nodes. By utilizing this approach, navigation between nodes does not require the inspection of properties within nodes, increasing the efficiency of performing this operation.

These diagrams show the use of one reference association, however multiple reference associations may exist within a schema. An example is an application, /application/Notes, associated with a desktop, /desktop/Standard/Finance, associated with a user, user/John. The schema would include reference associations /user/John//desktop/Standard/Finance, /desktop/Standard/Finance//application/Notes, and /user/John//desktop/Standard/Finance//application/Notes.

Referring now to FIG. 6 and the process of coalescing properties, two examples will be used to demonstrate coalescing.

First, a simple case where the reference association does not contain any properties will be shown. Fred's desktop would have the background set to green and the foreground set to white as found in associated node 610 and the screensaver set to “on” as determined by reducing node 610 to node 404 to determine the remaining properties not specified by node 610. It should be noted that node 608 is a reduced node of node 610, but since the same properties are specified in node 610 as in node 608, node 610 supercedes 608 and the node is reduced further to node 404 to find the remaining properties for Fred's desktop.

A second example shows a property within the reference association being used in the coalescing operation. In this case, node 416 contains reference association node 616 with a property indicating that John's desktop has the foreground color set to “cyan”. The rest of the desktop properties are found by navigating to “desktop/Standard/Sales” and coalescing within that hierarchy as for the previous example. Thus, John's desktop would have a foreground of cyan with a background of blue as found in the node “desktop/Standard/Sales” 612, with the screensaver set to “on” as determined by reducing node /desktop/Standard/Sales 612 to node /desktop 404 which contains the remaining properties not specified in node 612. As shown, both properties in 608 are already assigned before its inspection, so both its property values are ignored.

Again, in similar fashion, node 418 comprises node 518 which specifies that Jane's desktop properties are found in node 608. Thus, Jane's desktop properties specifies that the background color is yellow and the foreground color is black with the screensaver set to “on” as determined by reducing node 608 to node 404.

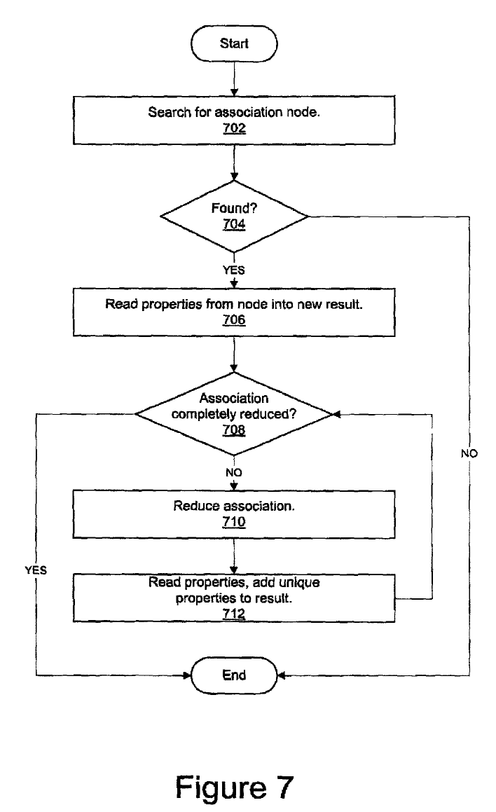

With reference now to FIG. 7, a diagram illustrating a program flow for determining the properties of a node within a hierarchical schema, such as depicted in FIG. 6, is depicted in accordance with the present invention. Once a node representing an element, such as a user within a networked computing environment, is found, it may be determined that it has reference associations to other nodes through inspection of its child nodes (step 702). Reference association nodes may be identified, for example, by the presence of a special delimiter, such as, for example, “//”, as described above. The properties found embedded within the reference association node are read into the coalescing results.

If no association node is found for the node (step 704), then the process of obtaining the coalesced properties ends. If an association node is found for the node (step 704), then the properties from the reference association node are read into the properties result (step 706). If the association node is completely reduced (i.e. it is a top level node) (step 708), then the process of obtaining the node's properties ends.

If the association node is not completely reduced (step 708), then the association node is reduced (step 710) and the unique properties from the reduced association node are appended to the properties result for the node (step 712). The process of reducing the association node and obtaining unique properties from each reduced node continues until the association node has been completely reduced.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for utilizing a schema of a hierarchy to represent a reference association between nodes in a hierarchy comprising:
adding a first child node to the hierarchy node that holds the reference association; and
determining, from a second child node, a location of the reference association whose presence is indicated by a delimiter, wherein the reference association node contains properties to be associated with the second child node; and
locating the reference association node to obtain properties to be coalesced with the properties of the second child node.

2. The method as recited in claim 1, wherein the reference association is a plurality of reference associations wherein the schema contains multiple reference associations separated by the reference association delimiter.

3. A method for determining a coalesced set of properties from a set of nodes, the method comprising:
initially populating a result set of properties by retrieving a set of first properties from a reference association node;
reducing the association node to obtain the schema of a reduced node;
determining a set of unique second properties from the reduced node that are different from the set of first properties; and
adding the set of unique second properties from the reduced node to the result set of properties.

4. The method as recited in claim 3, further comprising the continuous reduction of the schema to acquire all properties for the result set of properties.

5. The method as recited in claim 3, further comprising:
writing the first and second property into a properties result.

6. The method as recited in claim 3, wherein the properties result is presented to a user.

7. The method as recited in claim 3, wherein the properties result is stored in a computer memory.

8. A computer program product in a computer readable media for use in a data processing system for utilizing a schema of a hierarchy to represent a reference association between nodes in a hierarchy, the computer program product comprising:
first instructions for adding a first child node to the hierarchy node that holds the reference association; and
second instructions for determining, from a second child node, a location of the reference association whose presence is indicated by a delimiter, wherein the reference association node contains properties to be associated with the second child node; and
third instructions for locating the reference association node to obtain properties to be coalesced with the properties of the second child node.

9. The computer program product as recited in claim 8, wherein the reference association is a plurality of reference associations wherein the schema contains multiple reference associations separated by the reference association delimiter.

10. A computer program product for determining a coalesced set of properties from a set of nodes, the computer program product comprising:
first instructions for initially populating a result set of properties by retrieving a set of first properties from a reference association node;
second instructions for reducing the association node to obtain the schema of a reduced node;
third instructions for determining a set of unique second properties from the reduced node that are different from the set of first properties; and
fourth instructions for adding the set of unique second properties from the reduced node to the result set of properties.

11. The computer program product as recited in claim 10, further comprising the continuous reduction of the schema to acquire all properties for the result set of properties.

12. The computer program product as recited in claim 10, further comprising:
fifth instructions for writing the first and second property into a properties result.

13. The computer program product as recited in claim 10, wherein the properties result is presented to a user.

14. The computer program product as recited in claim 10, wherein the properties result is stored in a computer memory.

15. A processing system for utilizing a schema of a hierarchy to represent a reference association between nodes in a hierarchy, the computer program product comprising:
first means for adding a first child node to the hierarchy node that holds the reference association; and
second means for determining, from a second child node, a location of the reference association whose presence is indicated by a delimiter, wherein the reference association node contains properties to be associated with the second child node; and
third means for locating the reference association node to obtain properties to be coalesced with the properties of the second child node.

16. The system as recited in claim 15, wherein the reference association is a plurality of reference associations wherein the schema contains multiple reference associations separated by the reference association delimiter.

17. A system for determining a coalesced set of properties from a set of nodes, the system comprising:
first means for initially populating a result set of properties by retrieving a set of first properties from a reference association node;
second means for reducing the association node to obtain the schema of a reduced node;
third means for determining a set of unique second properties from the reduced node that are different from the set of first properties; and
fourth means for adding the set of unique second properties from the reduced node to the result set of properties.

18. The system as recited in claim 17, further comprising the continuous reduction of the schema to acquire all properties for the result set of properties.

19. The system as recited in claim 17, further comprising:
fifth means for writing the first and second property into a properties result.

20. The system as recited in claim 17, wherein the properties result is presented to a user.

21. The system as recited in claim 17, wherein the properties result is stored in a computer memory.
